(19) United States
(12) Patent Application Publication
(10) Pub. No.: US 2007/0192719 A1
(43) Pub. Date: Aug. 16, 2007

(54) Hover indicator for objects

(75) Inventors: Keith Barton Chellis, Kirkland, WA (US); James D. Macauley, Bellevue, WA (US); Stuart N. DeSpain, Seattle, WA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/351,407

(22) Filed: Feb. 10, 2006

(51) Int. Cl. G06F 3/00

(52) U.S. Cl. 715/767

(57) ABSTRACT

Technology is disclosed for identifying embedded objects in a user interface. The technology identifies the objects when a user interface device is positioned over the object. The technology is included in a computer system having a graphical user interface, a display and a user interface selection device. A method of illustrating a characteristic of an object in a document on the display comprises the steps of retrieving an event indicating the position of the user interface selection device over an object; and displaying an indicator illustrating boundaries of the object in a document.

### BACKGROUND

Productivity applications such as those available in the Microsoft® Office suite of applications allow users to create a number of different types of documents incorporating various types of data objects. Objects include both native objects created by the application, such as text boxes as well as images and multimedia components. Embedded objects can include objects created with one application and embedded into a document created by another application. Embedding the object, ensures that the object retains its original format.

Often, only portions of these objects are seen in the display version of the document, with some of the data from the object being hidden for various reasons. Currently, there are only limited mechanisms for selecting these objects and making them visible to the user. To manipulate objects, a user generally must first select the object in the user interface. Often it can be difficult to determine an object's boundaries, making it difficult to select, especially when an object obscures another. It is also difficult to determine what an obscure object is fully without moving the object away from the other object. In general, users have a hard time determining what happened to objects such as graphics that happen to be covered by other graphics and understanding layering of objects.

### SUMMARY

Technology is disclosed for identifying embedded objects in a user interface when a user interface device is positioned over the object. The technology is included in a computer system having a graphical user interface, a display and a user interface selection device. A method of illustrating a characteristic of an object in a document on the display comprises the steps of retrieving an event indicating the position of the user interface selection device over an object; and displaying an indicator illustrating boundaries of the object in a document. In certain embodiments, the style of indicator displayed is dependent on the type of object over which the selection device is positioned.

In another implementation, a method in a computer system for displaying an indicator of an object on a display device is presented. The indicator shows a location and boundaries of the object. The method may comprise the steps of: determining a position of a user controlled cursor over an object in a document; and displaying an indicator illustrating at least boundaries of the object in a document. In a further implementation, the method may include displaying a first style of indicator with a first type of object and a second style of indicator with a second type of object.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a depiction of a processing device suitable for implementing the technology discussed herein.

FIG. 2 is a flowchart illustrating one embodiment of a method in accordance with the technology disclosed herein.

FIG. 3A is an illustration of a sample document including embedded objects.

FIG. 3B is an illustration of a current indicator for a selected object.

FIG. 4A is in illustration of a first indicator used in the present technology

FIG. 4B is an illustration of a second indicator used in the present technology

FIG. 5 is an illustration of a first selection indicator used in the present technology.

FIG. 6 is an illustration of a second selection indicator used in the present technology

FIG. 7 is an illustration of an indicator for an image or drawing object.

FIG. 8 is an illustration of an indicator for a partially obscured image or drawing object.

FIG. 9 is an illustration of an indicator for a selected, partially obscured drawing object.

### DETAILED DESCRIPTION

Technology is disclosed for identifying objects in a document in a user interface. The technology identifies the objects when a user interface device is positioned over the object. In one embodiment, an object-type dependent indicator is presented when a user positioned a cursor or pointer over an object. The object dependent indicator can be a halo, or band of color, around an object that the mouse cursor is currently hovering over. In other cases, a translucent mask to overlay on the object is used. In addition, obscured portions of objects are presented. This overcomes shortcomings in previous attempts to address this issue which do not identify objects on mouse-over or mouse-hover events.

The technology disclosed herein allows users to readily identify objects embedded in documents, and quickly determine the scope and content of those objects. The technology allows one to more readily view and determine the boundaries of obscured objects, such as text boxes and partially hidden images and drawings.

In one implementation, the technology is implemented in a user interface user productivity applications such as those which comprise the Microsoft® Office suite of applications, and provides the user with graphical information that can assist the user in determining the scope of objects. Such applications embed objects in documents. A document may be any file in any format for storing data for use by an application on a storage media. In particular, documents refer to any of the files used by the productivity applications referred to herein to store objects which may be rendered.

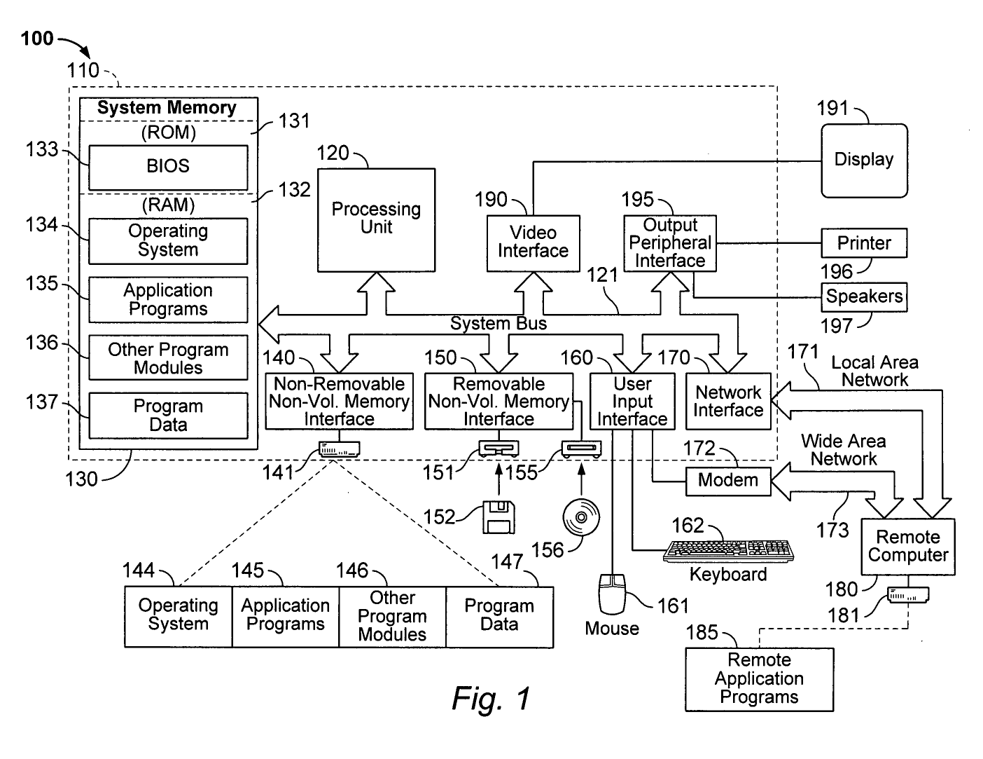

The present technology will now be described with reference to FIGS. 1 through 9, which relate to a GUI allowing users to interface with a computer operating system and/or application programs running in conjunction with the operating system. The present system may operate over a wide variety of operating systems using user interfaces, including for example the Macintosh operating system by Apple Computer, Inc., the Windows® operating system from Microsoft Corporation, and the Linux operating system.

The GUI described herein can be implemented on a variety of processing systems. FIG. 1 illustrates an example of a suitable general computing system environment 100 on which the present system may be implemented. The computing system environment 100 is only one example of a suitable computing environment and is not intended to suggest any limitation as to the scope of use or functionality of the system. Neither should the computing system environment 100 be interpreted as having any dependency or requirement relating to any one or combination of components illustrated in the exemplary computing system environment 100.

The present system is operational with numerous other general purpose or special purpose computing systems, environments or configurations. Examples of well known computing systems, environments and/or configurations that may be suitable for use with the present system include, but are not limited to, personal computers, server computers, multiprocessor systems, microprocessor-based systems, set top boxes, programmable consumer electronics, network PCs, minicomputers, mainframe computers, laptop and palm computers, hand held devices including personal digital assistants and mobile telephones, distributed computing environments that include any of the above systems or devices, and the like.

The present system may be described in the general context of computer-executable instructions, such as program modules, being executed by a computer. Generally, program modules include routines, programs, objects, components, data structures, etc., that perform particular tasks or implement particular abstract data types. The present system may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the present system includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, and removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, random access memory (RAM), read only memory (ROM), electrically erasable programmable read-only memory (EEPROM), flash memory or other memory technology, CD-ROM, digital versatile disks (DVD) or other optical disk storage, magnetic cassettes, magnetic tapes, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 130 includes computer storage media in the form of volatile and/or nonvolatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, DVDs, digital video tapes, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. These components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

The application programs 135 stored in system memory 130 may include the GUI for performing the present system as described hereinafter. When one of the application programs including the GUI of the present system is launched, it runs on the operating system 134 while executing on the processing unit 120. An example of an operating system on which the application programs including the present GUI may run is the Macintosh operating system by Apple Computer, Inc., but the application programs including the present GUI may operate on a variety of operating systems including also the Windows® operating system from Microsoft Corporation, or the Linux operating system. The application programs including the present GUI may be loaded into the memory 130 from the CD-ROM drive 155, or alternatively, downloaded from over network 171 or network 173.

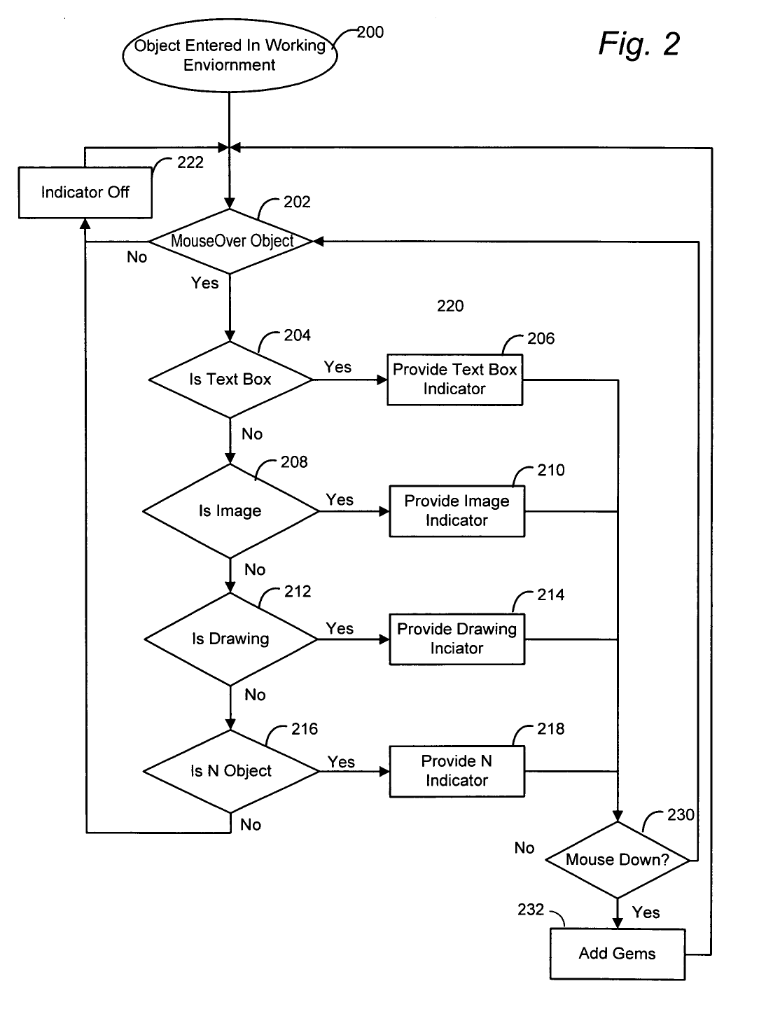

The present technology will now be described in reference to the flowcharts of FIGS. 2 through 9. FIGS. 2-9 illustrate an embodiment of the system using an application program such as Microsoft Word. It should be understood that the technology discussed herein may be used with any application program which supports native or embedded objects.

In this context, an embedded object may refer to a broad range of graphical, linkable objects which may include text, graphics, multimedia, or other content, including objects created from other applications. The present technology provides an interface which may be contextually adjusted for a variety of application programs, e.g., word processing, presentation, spreadsheet, drawing, and/or other application program types. Each embedded object has boundaries which define the size of the object in the document. Such boundaries are editable by the user, generally when a user “selects” the object by clicking on the object in a manner allowed by the application.

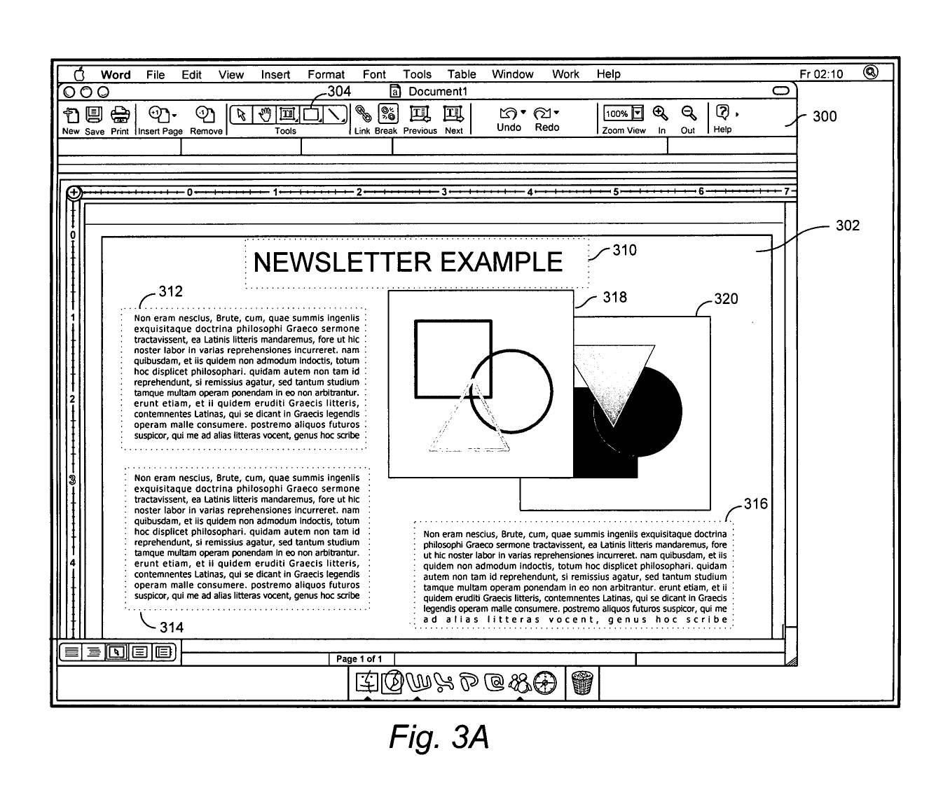

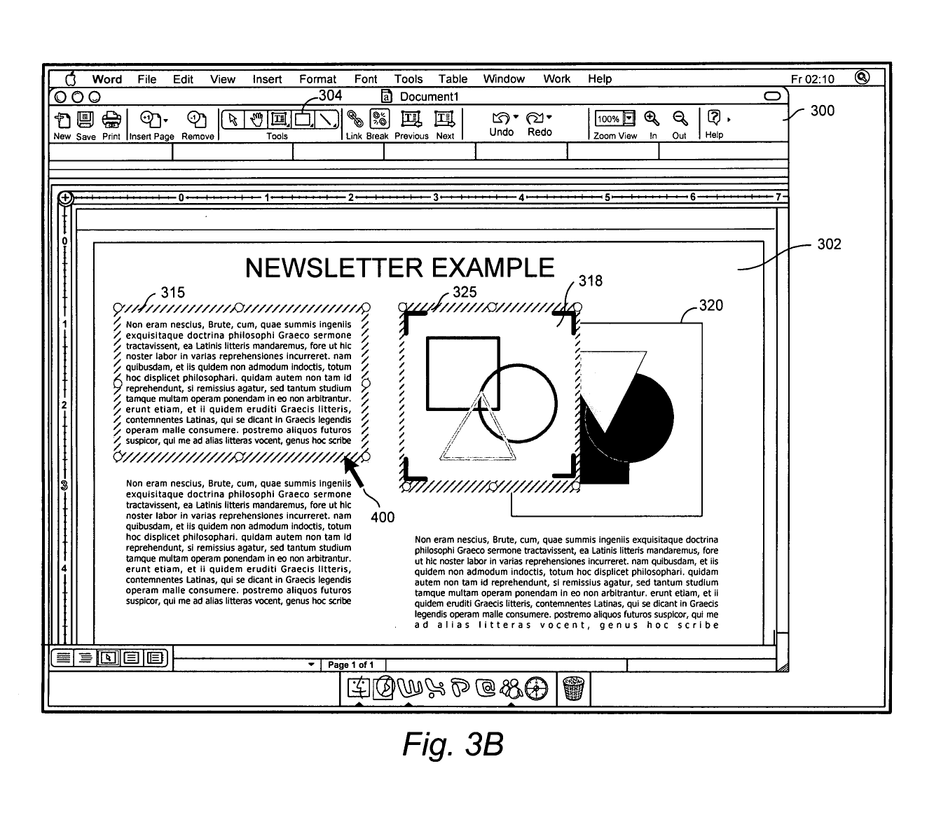

FIG. 2 is a flowchart representing a general implementation of the interface technology. FIGS. 3A and 3B show a exemplary document “NEWSLETTER EXAMPLE” with objects shown in a presentation view and “selected object” view, respectively.

In general, upon launching an application program, a graphical user interface is presented a user interface on a device such as a monitor 191. As shown in FIG. 3A, the interface includes a document window 300 having document 302 and tools 304 for entering and managing information such as text and objects on document 302. Document 302 may consist of text entered into paragraphs or text box objects 310, 312, 314, 316, images or drawings 318, 320, or other objects.

At step 200 of FIG. 2, an object is entered into the working environment document. Objects may be entered into the working environment by the user via a variety of mechanisms, depending on the application program and the tools available in the program. When using Microsoft Word, for example, drop-down menus and tool bars allow the user the ability to “Insert” objects selected from files or to directly “cut and paste” objects into the working environment.

At step 202, the technology determines whether a mouse cursor 400 is positioned over an object. Each object is uniquely identified within the environment, and application development environments include mouse tracking capabilities which monitor mouse events of the mouse based on events which are linked to the operating system. For example, Microsoft Windows includes MouseDown, MouseEnter, MouseHover, MouseMove and other events which track the cursor movement. In step 202, in one embodiment, the MouseHover event is used to determine when the cursor or pointer 400 is positioned over an object in the working environment document.

If a cursor is positioned over an object, a determination is made at steps 204, 208, 212 and 216 as to the type of object, and a type dependent indicator presented to the user to identify the object. Steps 204, 208, 212 and 216 identify whether the object is a text box (204) an image (208) a drawing (212) or some other type of object (216). If the item is a text box at step 204, then a text box indicator is provided at step 206. If the item is an image at step 208, an image indicator presented at step 210. If the item is a drawing at step 212, a drawing indicator is provided at 214. For any other type of object “N” at step 216, a custom indicator 218 may be provided. If the object is undefined, the method returns to step 202 with no indicator being provided at step 222.

Steps 202-232 of FIG. 2 operate continuously, on a per-object basis. Step 202 may be performed by continuously monitoring the mouse position relative to the objects in the document. As such, when the mouse pointer 400 is not over an object at step 202, or the mouse pointed moves to a different location or object the indictor is removed and no indicator is provided. Step 202 is also performed on a per object basis. That is, the state of the determination at step 202 is made for one given object such that if the cursor moves off the object, the determination at step 202 is negative and the indictor removed at step 222. If the cursor is positioned from one object to another object, a first instance of the method of FIG. 2 for the first object will be negative, removing the indictor, while a second instance of the method will generate an indicator over the second object.

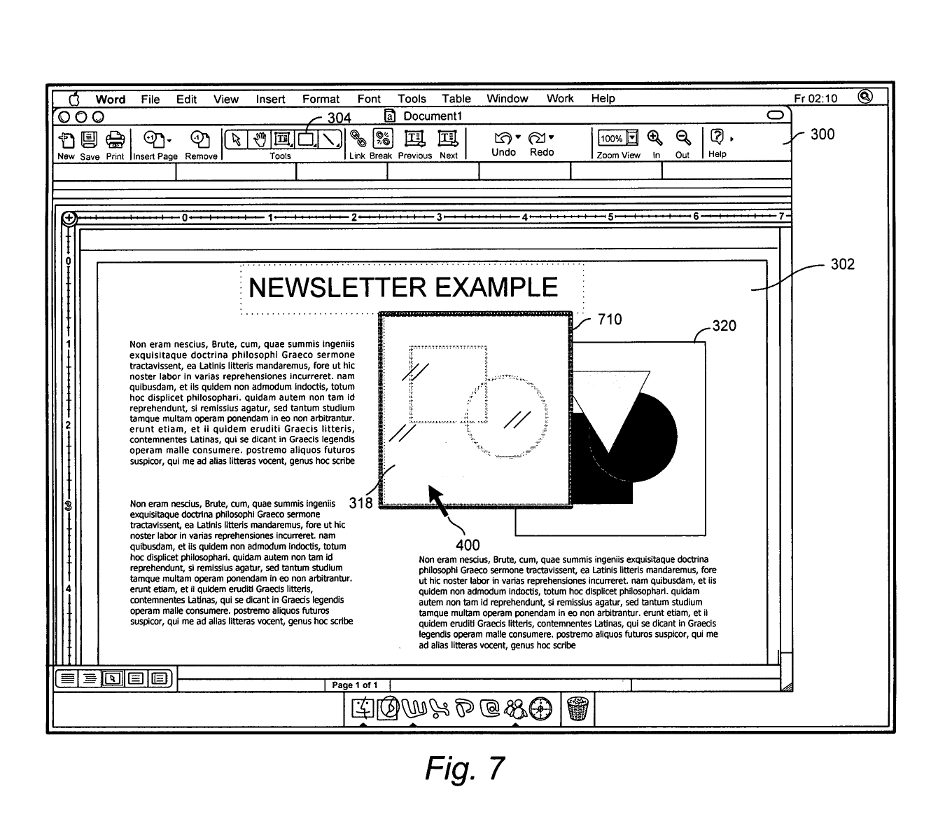

Application programs generally allow for the user to “select” an object to further manipulate the object. Usually, selecting an object occurs on the MouseDown event either on an object's border or within the object's defined area. If a mouse down event occurs at step 230, object handles or gems may be added at step 232. This is illustrated with respect to FIGS. 7, 8 and 9.

FIG. 3 illustrates an exemplary graphical user interface presented by an application program such as Microsoft Word. In the document 302, a number of types of objects are shown. As noted above, the document NEWSLETTER EXAMPLE includes a title (text) box 310, text boxes 312, 314, and 316 and graphical images 318 or 320. In FIG. 3A, the text boxes are illustrated by dashed lines; however, it will be understood that the dashed lines are only shown to illustrate the bounds of each text box, and such lines are not normally presented to a user in the graphical views shown in FIGS. 3-9. Normally in a view such as that shown in FIG. 3, the text boxes appear without the dashed boxes around them. It will be further understood that while the images 318 and 320 are identified as images, they may also be drawings generated by an drawing subsystem of the application program, multi-media objects, or other objects, such as those created by other application programs.

Most application programs which support embedded objects also support the capability of organizing such objects in layers. In general, embedded objects inserted into a document are inserted in successive, stacked layers. Generally, objects can be placed in separate layers and freely moved under or over each other. Objects may be managed individually or in groups. In FIG. 3A, object 318 is in a layer stacked above object 320 so that a portion of object 320 is obscured by image 318. Layers provide different capabilities depending on the type of application.

As noted above, unless an object is selected, there is generally no indication of the bounds of the object. For example, a text box object merely appears as text on the document page. FIG. 3B shows an example of how a selected text box 312 and a selected image 318 appear using current indicators in, for example, Microsoft Word. As shown therein, when a text box, image or other object is selected, it is surrounded with a hatched box with gems. The gems allow the object to be repositioned or resized. The box is hatched in black and white, or whatever colors the document is viewed in. It should be emphasized that these objects are only shown with cross-hatching when the object is selected using, for example, a MouseDown event or a double click event when the cursor is positioned in the correct screen space of the document.

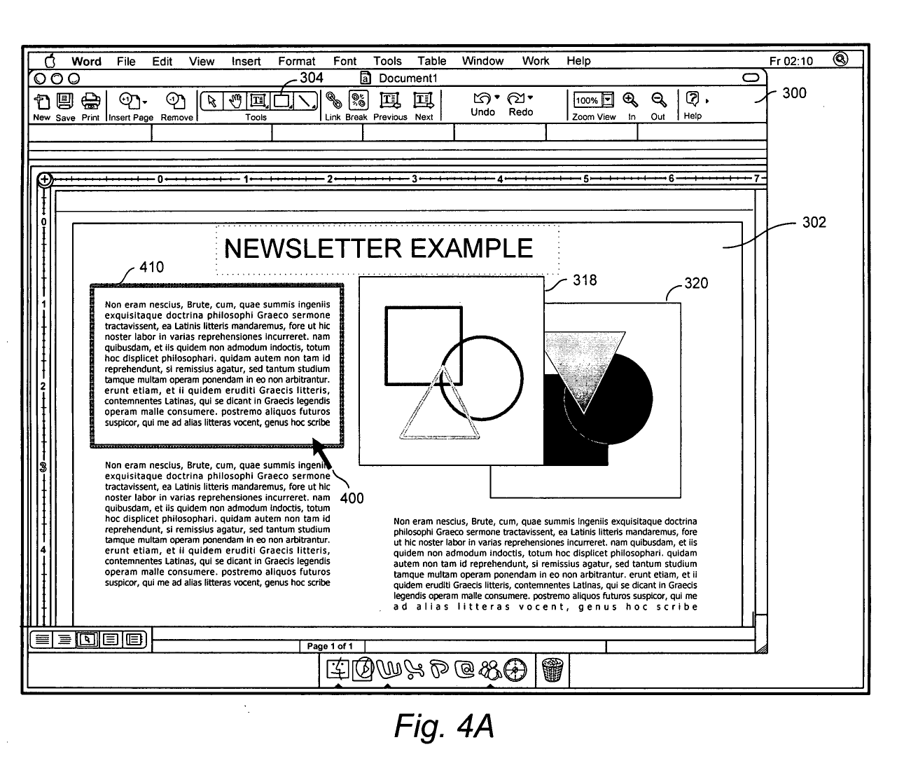

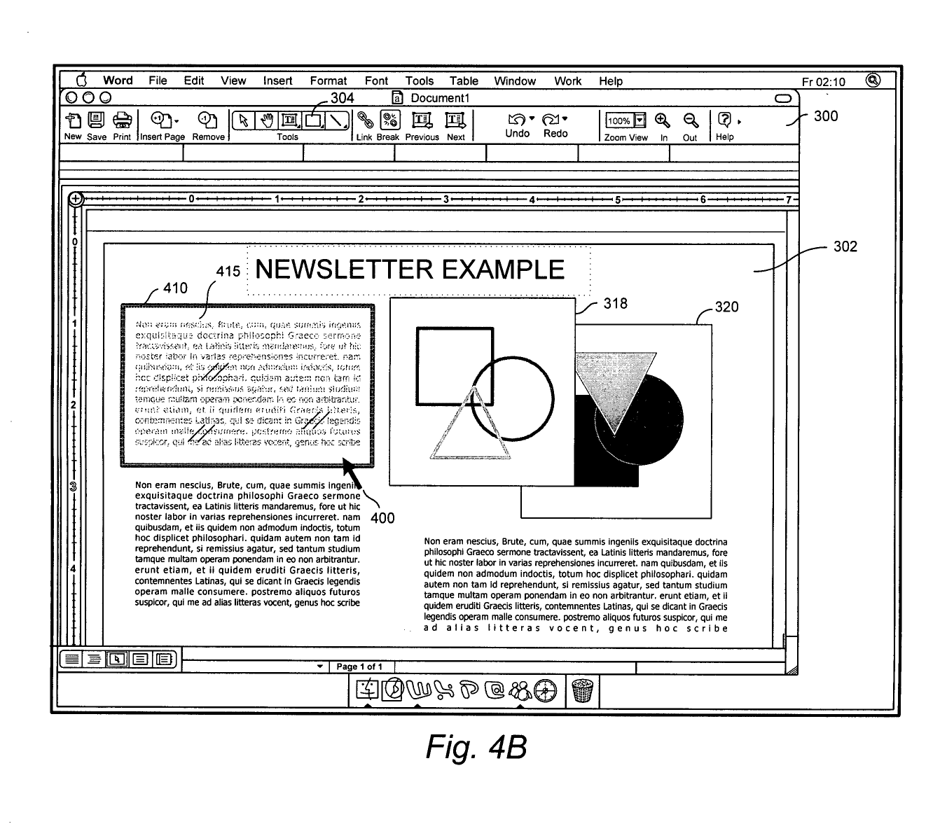

FIG. 4A illustrates a first implementation of the technology in accordance with the present invention wherein a text box indicator such as that described above with respect to step 206 is provided. In accordance with the technology, on a MouseHover (or equivalent) event, when a pointer 400 is positioned over a text box, a halo or highlight stroke 410 is provided around the border of the text box object. The highlight stroke is, in one embodiment, provided in a color other than black or white (or other document colors) and in a suitable width (for example, greater than 2 pixels) to clearly indicate the bounds of the object.

By providing the object indicator on the MouseHover event, the presence of the object is more easily discernible to the user, and the user is better able to manipulate objects. In addition, by providing the object in a different color than the document colors, the object is easily separable from other elements of the document. It will be well understood that the capability of rendering the halo stroke or transparent box is generally included in the development environment and is well known.

An alternative indicator is shown in FIG. 4B where both a highlight or halo stroke 410 and a transparent overlay 415 are provided. The transparent overlay is, in one embodiment, a transparent gray or white filled box which results in the underlying text, graphic or other object appearing somewhat lighter than the original appearing in the document. As illustrated in FIG. 4B, the text in the text box 312 is lighter than in FIG. 4A.

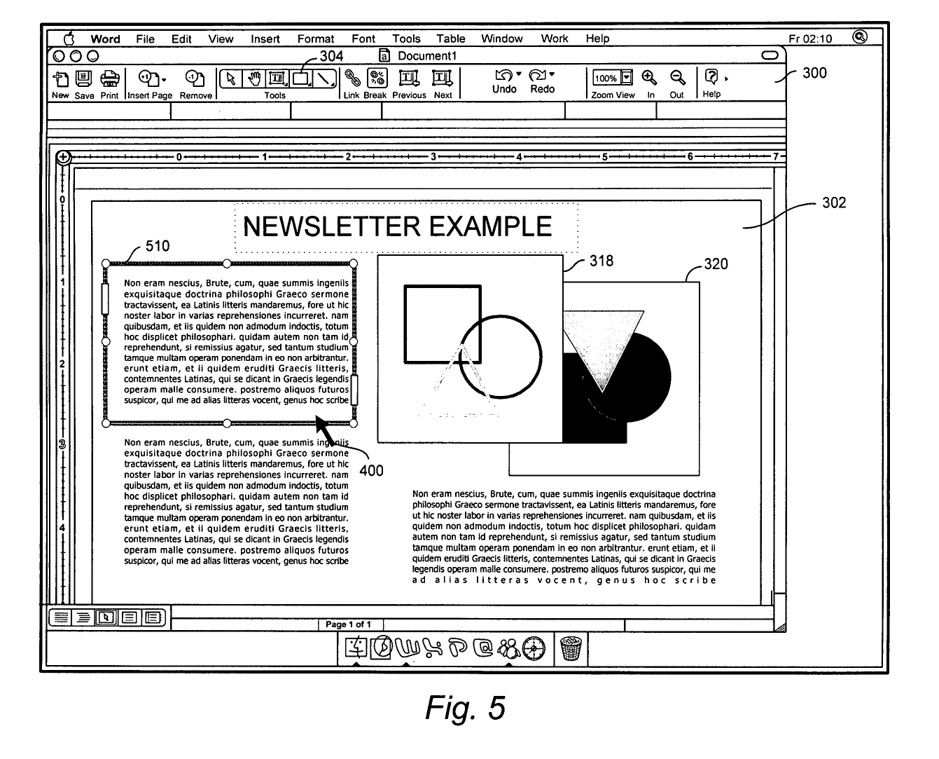

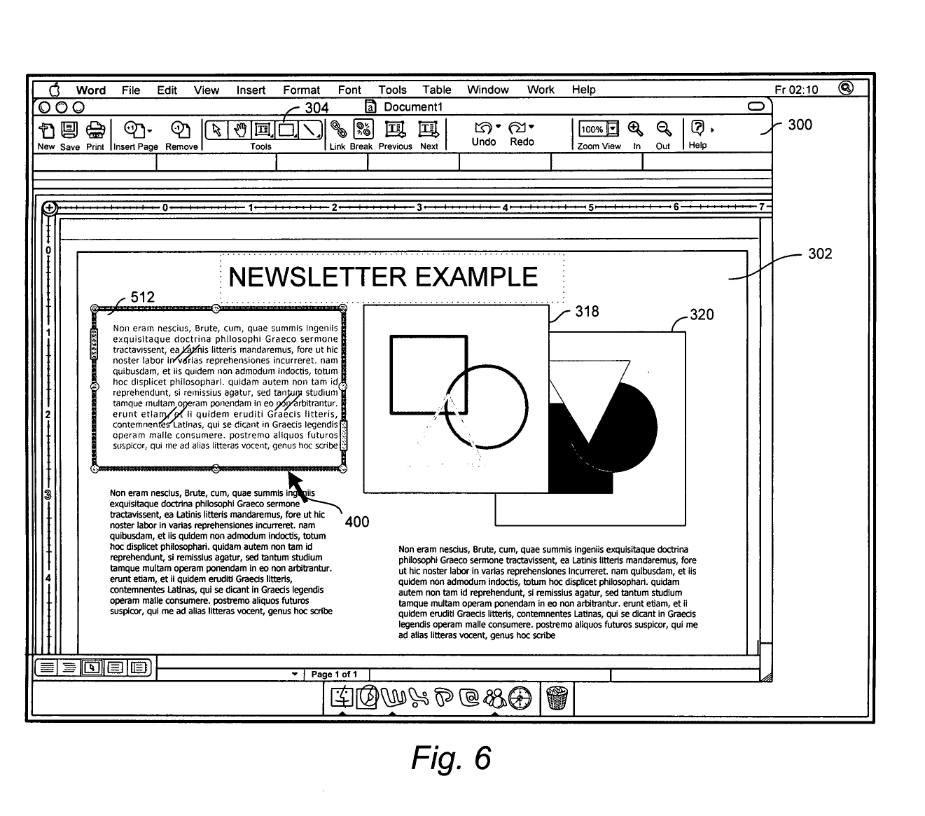

FIG. 5 illustrates an indicator used to denote when the object has been selected, in accordance with step 232. As noted above, the selection indicator is provided when a mouse down event occurs within the boundary of the object. In one embodiment, gems are added to the highlight stroke to provide an indicator illustrated by graphic 510. In this event, the gems added to the color highlight 410 provide re-size and movement functionality for the object. In another embodiment, the transparent overlay may be used in combination with the highlight 512 as shown in FIG. 6. In still another embodiment, the color of the highlight may change or a texture may be added to the highlight. In still another embodiment, a selection indicator such as those shown in FIG. 3B may be used.

FIG. 7 illustrates an indicator such as those described above with respect to steps 210 and 214 when a pointer 400 is positioned over graphic 318. Again, this may occur in accordance with steps 202 and 202, 221 when a MouseHover event occurs in the boundary of the object 318. As shown therein, a halo stroke 710 is provided about the object. In one embodiment the halo stroke 710 is colored differently from the document colors. In one alternative, the color is the same for all objects regardless of type, but in another alternative, the color of the halo strokes used on different types of objects changes with the type of object. For example, the text box may be presented with a green halo stroke and an image with a red halo stroke. In another alternative, the halo stroke may be used alone for graphics and drawings, or, as shown in FIG. 7, may be used in combination with a transparent overlay. As noted above, the transparent overlay comprises a transparent, shaded box and gives the appearance of a translucent object.

In the example shown in FIG. 7, object 318 is positioned over object 320, so the user's perception of objects 318 and 320 does not change. However, in a further aspect of the technology, obscured portions of objects are presented as part of the indictor for that object.

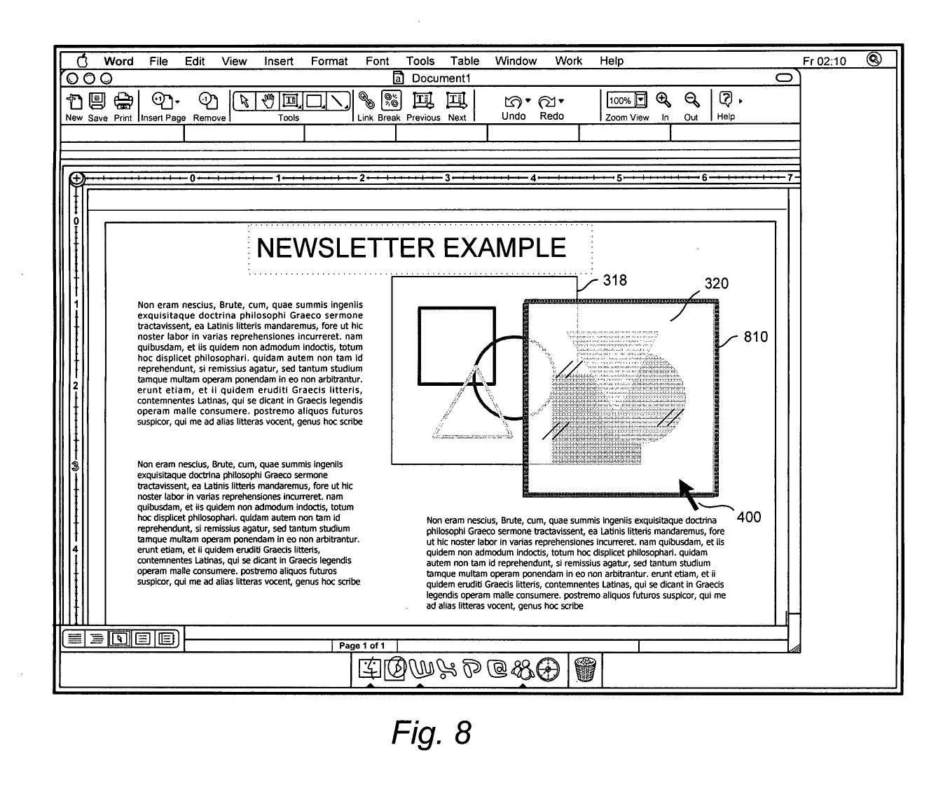

FIG. 8 shows an example of an image indicator which may be presented at 210 214 when a cursor 400 is positioned over an object which is partially obscured by another object. In FIG. 8, a halo stroke 810 is provided about the object, a transparent overlay is provided about the object, and a portion of the object which is obscured by image 318 is made to appear translucent to reveal the obscured portion of the object to the user. In the embodiment shown in FIG. 8, transparency is added to the obscured portion of the lower object (320) so the obscuring portion of the higher object (318) remains partially visible. In another alternative, the top object may also be made partially transparent to reveal the object below.

Translucency is added to the obscured portion of lower object (320 when displayed for consistency in indicating the bounds of the object 320. However, by displaying the obscured portion of the lower object, the user can see the entire underlying picture.

In one implementation, the indicator presented in FIG. 8 is provided by drawing the stroke about the object and clipping the obscured portion of the lower image. It should be noted that an image which is on a lower layer may be obscured by more than one image or object overlying it. In such a case, the technology determines whether the object is obscured and which portions of the object are obscured. For an image, those portions which are obscured are clipped at the boundaries where overlying objects intersect with the lower object, and the clipped portions displayed with the aforementioned translucent overlay in order to make the image appear translucent. However, as shown in FIG. 8, all portions of the underlying image can be shown.

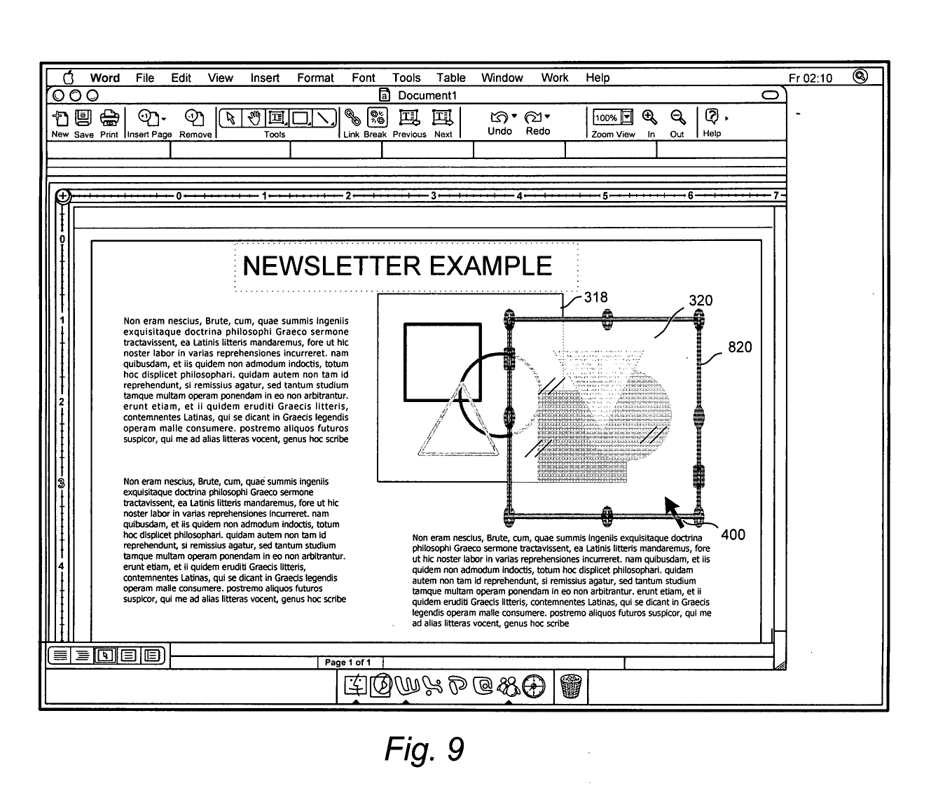

FIG. 9 illustrates the indicator 820 provided upon selection of a mouse down event, panels can be added as shown in FIG. 9. As shown therein, control gems are added to the indicator of FIG. 8. In alternative embodiments, the halo stroke may change color and/or the transparency and translucency may be removed when the object (320) is selected.

The technology discussed herein provides the advantage that objects are shown on a hovering aspect of the pointer. For an image, one needs to determine how much of the image is masked and click the regions on the image that are masked and replicate those above everything else.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. In a computer system having a graphical user interface including a display and a user interface selection device, a method of illustrating a characteristic of an object in a document on the display, comprising the steps of:
(a) retrieving an event indicating the position of the user interface selection device over an object; and
(b) displaying an indicator illustrating boundaries of the object in a document.

2. The method of claim 1 wherein the indicator displayed is dependent on the type of object over which the selection device is positioned.

3. The method of claim 1 wherein the indicator is a colored boundary stroke.

4. The method of claim 1 wherein the indicator is a transparent box having boundaries matching boundaries of the object.

5. The method of claim 1 wherein the indicator is a colored boundary stroke in combination with a transparent box overlying the object.

6. The method of claim 1 wherein the indicator is a halo stroke alone for a text box and wherein the indicator is a halo stroke with a transparent box overlying the object for non-text box objects.

7. The method of claim 1 wherein at least two objects are provided in the document on the display, and wherein a portion of a first of said objects at least partially obscures a second of said objects, said second object having an obscured portion, and wherein the indicator includes displaying said obscured portion.

8. The method of claim 7 wherein said step of displaying said obscured portion includes rendering said obscured portion transparent.

9. The method of claim 7 wherein said step of displaying said obscured portion includes rendering said obscured portion with a transparent box overlying the object for non-text box objects.

10. A method in a computer system for displaying on a display device an indicator of an object, including a location and boundaries of the object, the method comprising the steps of:
(a) determining a position of a user controlled cursor over an object in a document; and
(b) displaying an indicator illustrating at least boundaries of the object in a document.

11. The method of claim 10 wherein the step of displaying includes displaying a first style of indicator with a first type of object and a second style of indicator with a second type of object.

12. The method of claim 11 wherein the first style of indicator is a boundary stroke having a first color and the second style of indicator is a boundary stroke having a different color.

13. The method of claim 11 wherein the first style of indicator is a boundary stroke having a color and the second style of indicator is a boundary stroke including a transparent overlay.

14. The method of claim 11 wherein the first style of indicator is a boundary stroke having a first color and the second style of indicator is a boundary stroke having a different color and a transparent overlay.

15. The method of claim 10 wherein at least two objects are provided in the document on the display, and wherein a portion of a first of said objects at least partially obscures a second of said objects, said second object having an obscured portion, and wherein the indicator includes displaying said obscured portion.

16. The method of claim 15 wherein said step of displaying said obscured portion includes rendering said obscured portion transparent.

17. The method of claim 15, wherein said step of displaying said obscured portion includes rendering said obscured portion with a transparent box overlying the object for non-text box objects.

18. A computer-readable medium having computer-executable instructions for performing steps comprising:
(a) retrieving an event indicating the position of the user interface selection device over an object; and
(b) displaying an indicator illustrating boundaries of the object in a document.

19. The method of claim 18 wherein the indicator displayed is dependent on the type of object over which the selection device is positioned, including displaying a first style of indicator of a boundary stroke having a first color and the second style of indicator of a boundary stroke having a different color.

20. The method of claim 18 wherein the style of indictor includes a transparent overly in said first or second style of indicator
